(19) United States
(12) Patent Application Publication
(10) Pub. No.: US 2009/0121455 A1
(43) Pub. Date: May 14, 2009

(54) JOGGER

(76) Inventors: Oliver KRETSCHMER, Sinsheim (DE); Christian WILKE, Rimbach (DE); Juergen CHRISTMANN, Bammental (DE)

Correspondence Address: Nixon Peabody LLP, 200 Page Mill Road, Palo Alto, CA, 94306, US

(21) Appl. No.: 12/208,688

(22) Filed: Sep. 11, 2008

(30) Foreign Application Priority Data
Sep. 19, 2007 (DE) 10 2007 045 068.2

(51) Int. Cl. B62B 3/02

(52) U.S. Cl. 280/642

(57) ABSTRACT

The invention relates to a jogger, in particular a child's rehabilitation jogger, with a framework (12) which comprises a front frame (14) with at least one front wheel (22) and a rear frame (16) with at least one rear wheel (28), a push rod (30) for pushing or pulling the jogger (10), a seat retainer (36) for accommodating a seat and a central element (38) which connects the front frame (14), the rear frame (16) and the push rod (30) locked and pivotably to one another, an actuating element (42) for releasing the central element (38) and a slider sleeve (56) which has a lock position, in which the front frame (14) is connected torque-proof to the rear frame (16) and a folding position, in which the front frame (14) can be pivoted relative to the rear frame (16). According to the invention it is provided for the central element (38) to have at least one slide element (82, 83) and the slider sleeve (56) to have a guide track (88) designed to slide away on the slide element (82, 83) such that rotating the slide elements (82) relative to the slider sleeve (56) about a central shaft (92) causes an axial shift of the slider sleeve (56) from the lock position to the folding position.

### BACKGROUND OF THE INVENTION

1. Field of the Invention

The invention relates to a jogger, in particular a children's rehabilitation jogger, with a) a framework, which comprises (i) a front frame with at least one front wheel and (ii) a rear frame with at least one rear wheel, b) a push rod for pushing or pulling the jogger, c) a seat retainer for accommodating a seat and d) a central element, which (i) connects the front frame, the rear frame and the push rod together so they can lock and pivot, (ii) an actuation element for releasing the central element and (iii) a slider sleeve, which has a lock position, in which the front frame is connected torque-proof to the rear frame and a folding position, in which the front frame can be pivoted relative to the rear frame.

2. Description of the Related Art

This type of jogger, which can also be designated as a buggy, is known for example from WO 2006/031115 A2. The jogger described here can be varied with respect to the position of the push rod. To make the jogger lighter for transporting an additional mechanism is provided to convert the framework holding the wheels into a folded state. The disadvantage of the known jogger is its high mechanical complexity. Since operating elements such as knobs in particular can easily break down, the known jogger is error-prone.

US 2007/0164538 A1 and EP 1 503 095 A1 disclose joints for strollers, both of which however infer considerable manufacturing expense.

### SUMMARY OF THE INVENTION

The aim of the present invention is to propose a jogger which is easy to manufacture.

The invention solves the problem via a generic jogger, in which the central element has a slide element and the slider sleeve has a guide track which is designed to slide on the slide element such that an axial shift of the slider sleeve from the lock position to the folding position can be effected by rotating the slide element relative to the slider sleeve about a central shaft.

An advantage here is that merely by rotating the slide elements relative to the slider sleeve, therefore by rotating the slide element when the slider sleeve is still, by rotating the slider sleeve when the slide element is still or with simultaneous counter-rotating of slide element and slider sleeve, the slider sleeve can be moved from the lock position to the folding position. Such movement can easily be triggered for example by the push rod whenever the slide element or the slider sleeve are arranged on the push rod. When the jogger is being used the push rod is in a position inclined to the horizontal, making it pleasant to push the jogger. By moving the push rod for example over the horizontal and down the slider sleeve can be moved to the folding position. This is how an actuating element is spared compared to known joggers. This facilitates production and results in lower costs. At the same time such a jogger is less accident-sensitive, since is has fewer parts to operate from the outside.

Since separate actuation elements for the folding mechanism can be omitted, the risk of soiling moving parts is also lower, potentially leading to functional breakdown. Further advantages are intuitive operabilility and a more appealing functional design.

In terms of the following description reference is made to front wheels and rear wheels. Yet this is an arbitrary definition, as the jogger can be altered such that it can be pushed with the rear wheels to the front through appropriate swivelling of the push rod.

It is understood by the feature of the front frame being pivoted relative to the rear frame, in particular according to common use of language, that either the front frame can be pivoted with the rear frame however staying still, or the rear frame can be pivoted with the front frame however staying still or the front frame and the rear frame can be pivoted.

An actuating element is understood in particular as any device of the jogger, which can be actuated by hand and can take up at least two positions, specifically a rest position and a release position. The actuation element is advantageously pre-tensed in the rest position, for example by a spring, and can be moved by hand to a release position. Only in the release position can the push rod be pivoted about the central axis relative to the framework. Releasing the actuation element fixes the push rod in a new position relative to the framework.

A slider sleeve is understood in particular to mean a component with substantially cylindrical base body. For function it is advantageous, though not mandatory, that the cylinder jacket is fully closed. In particular, the term “sleeve” does not mean that another object is always sheathed.

A guide track is understood in particular as any structure on the slider sleeve, which is designed to cooperate with the slide element such that swivelling of slider sleeve and slide element relative to one another results in axial shift. The guide track can be described by a guide track function at least in sections, which assigns a height to a radial coordinate about the central shaft along the central shaft. This guide track function is preferably constant. It is particularly preferably smooth, that is, constantly differentiable at least in sections.

According to a preferred embodiment the guide track is configured on an edge of the slider sleeve, resulting in particularly simple construction of the slider sleeve which can also particularly well absorb forces arising from the slide element slipping on the slider sleeve.

It is also favourable to build the guide track on an axial outer edge of the slider sleeve, facing the slide element. It is preferable that the slider sleeve has a substantially cylindrical base body and the guide track is designed on a front end of the base body. This results in particularly minimal demands on tolerances of the slide elements. Alternatively the guide track can be designed in a curved slot, in which a slide element in the form of a stud engages.

To ensure safe operation of the jogger the slider sleeve is preferably pre-tensed in the lock position. This prevents the slider sleeve accidentally moving to the folding position.

According to a preferred embodiment it is provided for the slider sleeve to be arranged relative to the framework such that it is in the lock position a push rod angle between the push rod and a horizontal is greater than a preset folding angle when the jogger is being used. The folding angle can for example be 0°. The folding angle is thus the angle between the horizontal and the push rod and when this is exceeded the slider sleeve reaches the folding position. The folding angle is measured from the push rod to the horizontal. If the push rod is above the horizontal, as is usual for normal use of the jogger, the folding angle is thus always greater than 0° and less than or equal to 90°. An angle of less than 0°, for example less than −35°, means that the push rod has been pivoted below the horizontal.

Particularly intuitive operation results when the folding angle corresponds substantially to a front frame angle, at which the front frame runs relative to the horizontal and/or a rear frame angle, at which the rear frame runs relative to the horizontal. In this case the slider sleeve goes straight to the folding position whenever the push rod runs substantially parallel to the front frame or respectively to the rear frame.

If the push rod angle is less than the folding angle the slider sleeve is preferably in the folding position, so that the front frame and the rear frame can be pivoted relative to one another and the jogger can be moved into a space-saving arrangement.

According to a preferred embodiment the central element is connected via a front frame head element to the front frame, connected to the rear frame via a rear frame head element and connected to the push rod via a push rod head element, whereby the front frame head element, the rear frame head element, the push rod head element and the slider sleeve are swivel-mounted coaxially about the central shaft and the slide element is designed on the push rod head element. Pivoting the push rod thus actuates folding. The front frame head element, the rear frame head element and the push rod head element are arranged preferably next to one another with respect to the central shaft.

A particularly simple possibility of moving the push rod to another push rod angle is for the push rod head element to comprise a control disc, which can be actuated by the actuating element, and at least one locking element which is pre-tensed for locking engagement in at least one locking pocket of the slider sleeve, whereby the control disc, the slider sleeve and the locking element are designed such that activating the actuation element disengages the locking element from the locking pocket so that the push rod can be pivoted relative to the framework.

In this case if the actuating element is shifted from a rest position, in which it can be pre-tensed, to a release position both locking sleeve and locking element are disengaged and the push rod can be swivelled until the locking element snaps into the adjacent locking pocket. If the actuating element is held uninterruptedly in the release position any push rod angle can be set. If the actuation element is then released the push rod snaps into the next preset push rod angle position.

An embodiment of the present invention will now be described hereinbelow in greater detail by means of the attached diagrams, in which:

### BRIEF DESCRIPTION OF THE DRAWINGS

FIG. 1 is a perspective view of an inventive jogger without seat,

FIG. 2 is a perspective view of a central element of the jogger according to FIG. 1,

FIG. 3 is an exploded view of the central element according to FIG. 2,

FIG. 4a is a plan view of a push rod head element of the central element according to FIGS. 2 and 3 in a rest position,

FIG. 4b is a plan view of the push rod head element of FIG. 4a from the rear side of the rest position, and

FIG. 4c is a view of the push rod head element according to FIG. 4a in a release position, and

FIG. 4d shows the push rod head element in the view according to FIG. 4b in the release position.

FIG. 5 shows the push rod head element from the side as in FIGS. 4a and 4c in a perspective view,

FIG. 6 shows the push rod head element from the side as in FIGS. 4b and 4d in a perspective view,

FIG. 7 shows the push rod head element according to FIG. 6 with removed control disc and removed locking elements, with two slide elements evident,

FIG. 8 shows a perspective side elevation of a slider sleeve of the central element according to FIG. 3,

FIG. 9 schematic illustrates the cooperation of a guide track of the slider sleeve and a slide element of the push rod head element, and

FIG. 10 shows a cross-section through the central element according to FIG. 3.

### DESCRIPTION OF THE PREFERRED EMBODIMENT

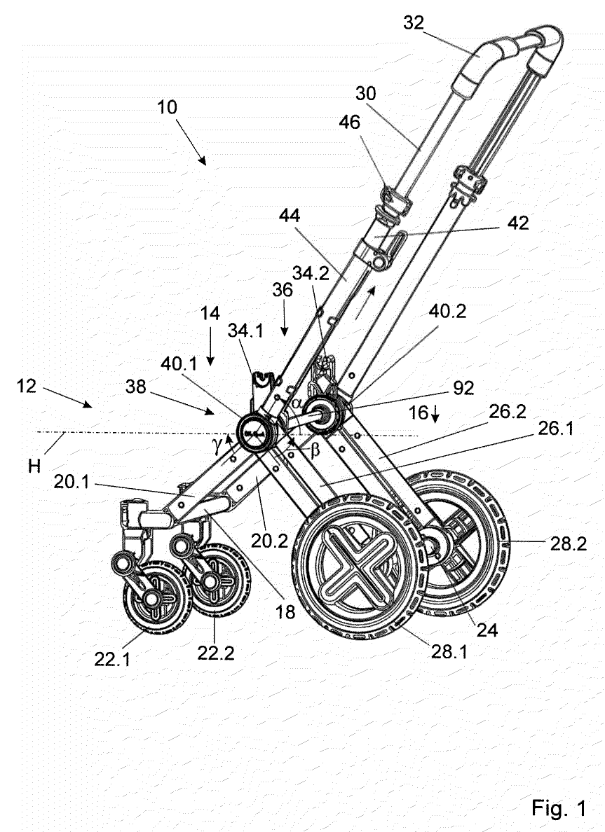

FIG. 1 shows a jogger 10 which has a framework 12, which in turn comprises a front frame 14 and a rear frame 16. The front frame 14 comprises a front frame transverse spar 18 and two front frame-lateral spars 20.1, 20.2, which are attached to the front frame transverse spar 18 to the side, as well as two front wheels 22.1, 22.2.

The rear frame 16 comprises a rear frame transverse spar 24, which is attached to two rear frame longitudinal spars 26.1, 26.2 and on which two rear wheels 28.1, 28.2 are suspended. The front frame transverse spar 18 is shorter than the rear frame transverse spar 24, so that both front wheels 22 can be pivoted between the rear wheels 28. Reference numerals without a suffix always designate the respective object in general.

The jogger 10 also comprises a push rod 30, on which a grip 32 is provided and which helps with pushing. The jogger 10 also has seat retainer elements 34.1, 34.2, which are jointly part of a seat retainer 36, designed to accommodate and carry a seat, not shown here.

Arranged adjacent to the seat retainer 36 is a central element 38 which connects the framework 12, the seat retainer 36 and the push rod 30 to one another. The central element 38 comprises a first joint 40.1 and a second joint 40.2, which are connected in each case to a front frame longitudinal spar 20, a rear frame longitudinal spar 26, a seat retainer element 34 and the push rod 30.

The first joint 40.1 and the second joint 40.2 are built identically for example mirror symmetric with respect to the components designated by the suffix “1”.

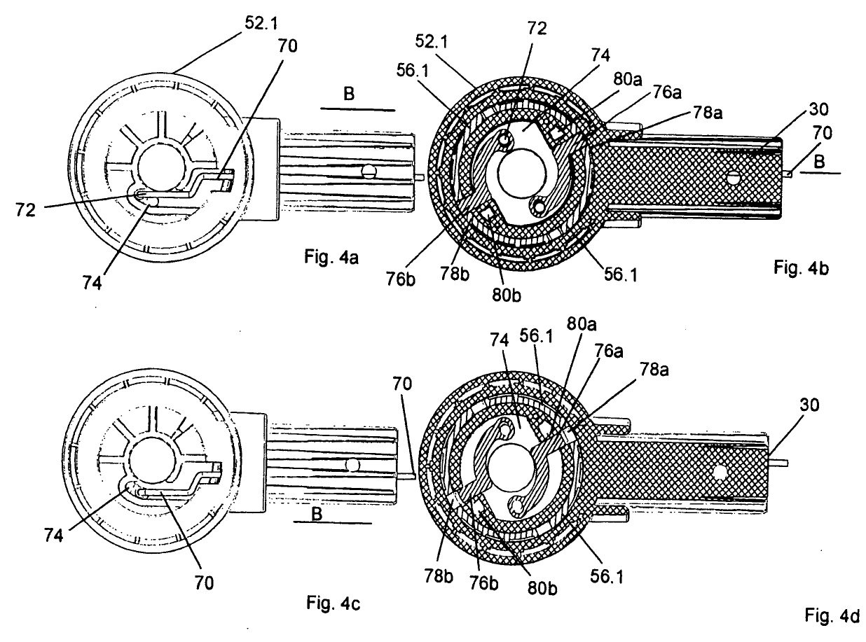

The first joint 40.1 comprises an actuating element 42, which has a finger grip 46 and an actuation rod connected to the finger grip 46 and not visible in FIG. 1. Pulling on the finger grip 46 moves the actuation rod (reference numeral 70, see FIGS. 4a to 4d below) in a direction of actuation B to the grip 32.

The push rod 30 forms a push rod angle α with a horizontal H when the jogger 10 is in the use position. The push rod angle α is greater than zero if the push rod 30 is above the horizontal H and is otherwise negative. The rear frame longitudinal spars 26 form a rear frame angle β of 45° with the horizontal H, which corresponds to a front frame angle γ, which the front frame longitudinal spars 20 form with the horizontal H.

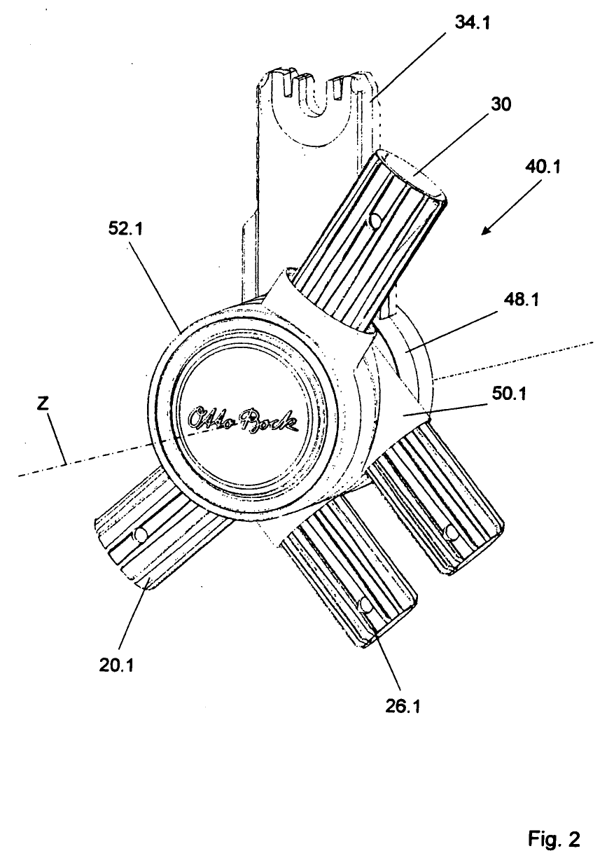

FIG. 2 shows a perspective view of the first joint 40.1. It is evident that the front frame longitudinal spar 20.1 terminates in a front frame head element 48.1 which is substantially discoid. In the same way the rear frame longitudinal spar 26.1 terminates in a rear frame head element 50.1 which likewise is designed discoid and together with the front frame head element 48.1 can be rotated about a central axis Z. The push rod 30 likewise terminates in a discoid push rod head element 52.1 which is arranged adjacent to the front frame head element 48.1 and the rear frame head element 50.1. The second joint 40.2 (FIG. 1) is built mirror symmetric, whereby the respective components bear the suffix “2”.

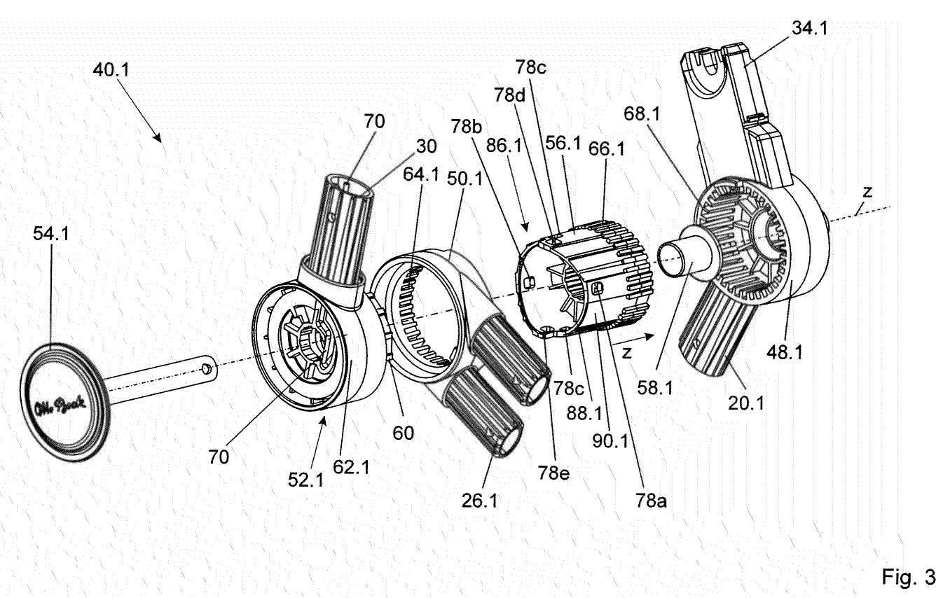

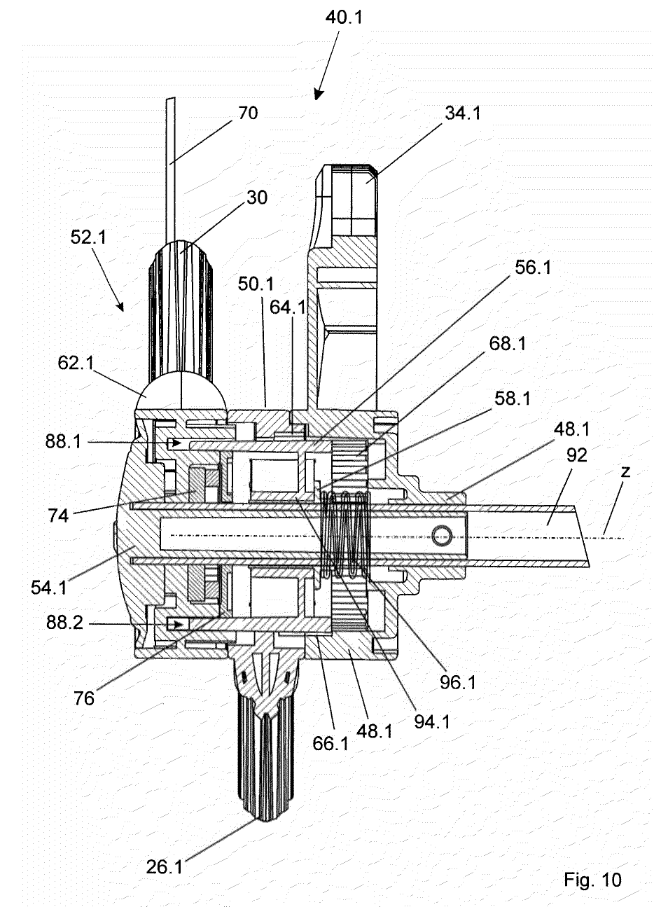

FIG. 3 shows an exploded view of the first joint 40.1 which comprises a cap 54.1, a slider sleeve 56.1 and a tensing element 58.1 in addition to the abovedescribed components. The tensing element 58.1 can also be called a slider sleeve and part of its purpose is to reduce the friction between the slider sleeve 56.1, into which it is inserted, and a central shaft not shown in FIG. 3 (reference numeral 92, see FIG. 10).

The push rod head element 52.1 has a coupling section 60 presenting projections, which cooperates positively with the recesses (not shown) in the rear frame head element 50.1, connecting the coupling section 60 to the rear frame head element 50.1. The coupling section 60 is formed in one piece on a base body 62.1 of the push rod head element 52.1.

The rear frame head element 50.1 has inner ribbing 641 designed to cooperate with outer ribbing 66.1 of the slider sleeve 56.1.

The inner ribbing 64.1 of the rear frame head element 50.1 also corresponds to inner ribbing 66.1 of the front frame head element 48.1. In a lock position the slider sleeve 56.1 with its outer ribbing 66.1 projects halfway into the inner ribbing 64.1 or respectively 68.1, so that the rear frame head element 50.1 is connected torque-proof to the front frame head element 48. In a folding position the outer ribbing 66 projects fully into the inner ribbing 68.1 of the front frame head element 48, though not into the inner ribbing 64.1, such that the rear frame head element 50.1 can be rotated.

FIGS. 4a to 4c explain the mechanism by which the push rod angle α can be altered.

FIG. 4a shows a view of the push rod head element 52.1 in a view from the left with respect to the view of FIG. 3. FIG. 4a shows an actuation rod 70 which is connected to the finger grip 46 not shown in FIG. 4a (cf. FIG. 1). Pulling on the finger grip 46 draws the actuation rod 70 in the direction of actuation B. Using a coupling end 72 averted from the finger grip 46 (cf. FIG. 1) the actuation rod 70 engages in a control disc 74, for the most part covered over in FIG. 4a. If the actuation rod 70 moves in the direction of actuation B in FIG. 4a the control disc 74 rotates counterclockwise. In FIG. 4a the actuation rod 70 is shown in a rest position, in which it is pre-tensed by a spring, not shown here.

FIG. 4b shows a view from the rear of the push rod head element 52.1 as per FIG. 4a. If the actuation rod 70 is pulled in the direction of actuation B the control disc 74 in FIG. 4b rotates clockwise. Attached to the control disc 74 are two locking elements 76a, 76b which in the rest position shown in FIG. 4b engage in each case in a locking pocket 78a or respectively 78b in the slider sleeve 56.1. Since the locking elements 76a, 76b are guided by assigned guides 80a, 80b, configured on the base body 62.1 (cf. FIG. 3), any rotating of the slider sleeve 56.1 relative to the base body 62.1 (cf. FIG. 3) of the push rod head element 52.1 is prevented.

FIG. 4c shows the case where the actuation rod 70 has been pulled in the direction of actuation B, causing the control disc 74 to rotate counterclockwise.

FIG. 4d shows that this pushes the locking elements 76a, 76b radially inwards so that they further rest on the assigned guides 80a, 80b, however have disengaged from the locking pockets 78a, 78b of the slider sleeve 56.1. In this situation the push rod 30 can be pivoted relative to the other elements of the first joint 40.1 (cf. FIG. 3).

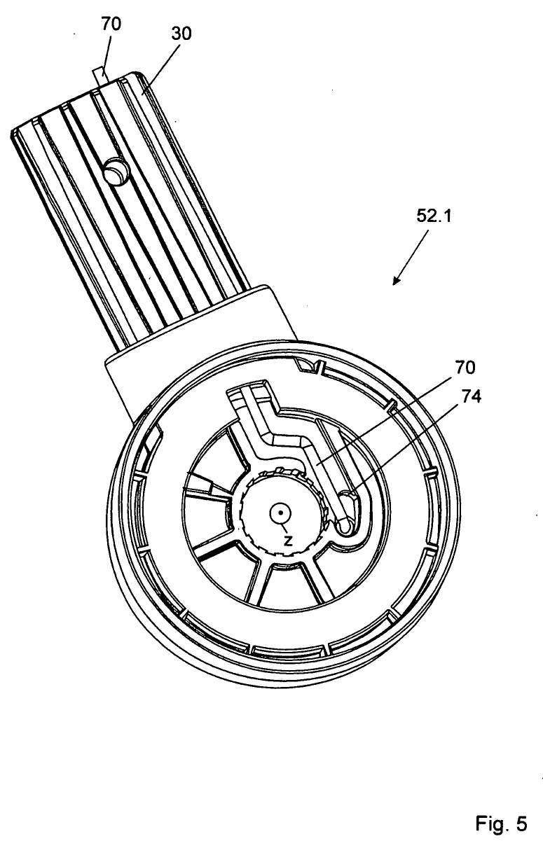

FIG. 5 shows the push rod head element 52.1 in a perspective view in the state according to FIG. 4a.

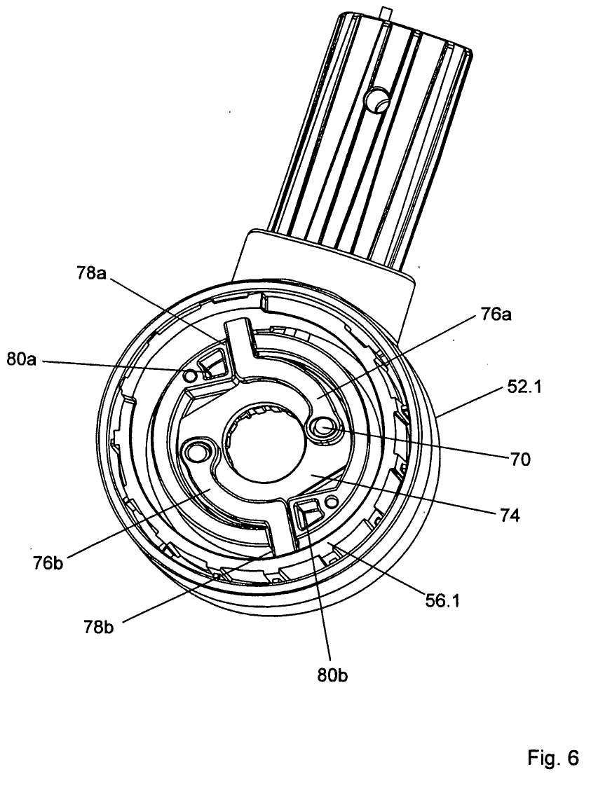

FIG. 6 shows a perspective view of the push rod head element 52.1 in a perspective view in the position according to FIG. 4b.

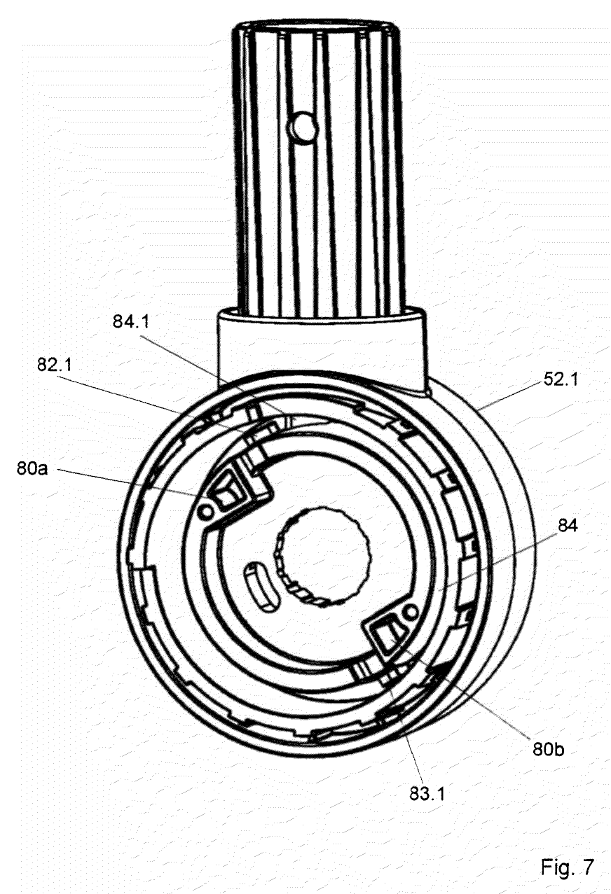

FIG. 7 shows another view of the push rod head element 52.2, in which two slide elements 82.1, 83.1 are evident. The slide elements 82 are arranged on the base body 62.1 in a circular groove 84.1 which is designed such that the slider sleeve 56.1 (FIG. 3) with a front end 86.1 can penetrate the latter. A guide track 88.1 shown in FIG. 3, configured on the front end 86.1 of the slider sleeve 56.1, now makes contact with the slide elements 82.1, 83.1.

If the slide elements 82.1, 83.1 relative to the slider sleeve 56.1 are rotated the guide track 88.1 on the one hand and the slide elements 82.1, 83.1 on the other hand glance off from one another, resulting in an axial shift along the central axis Z (FIG. 3) of the slider sleeve 56.1 relative to the push rod head element 52.1.

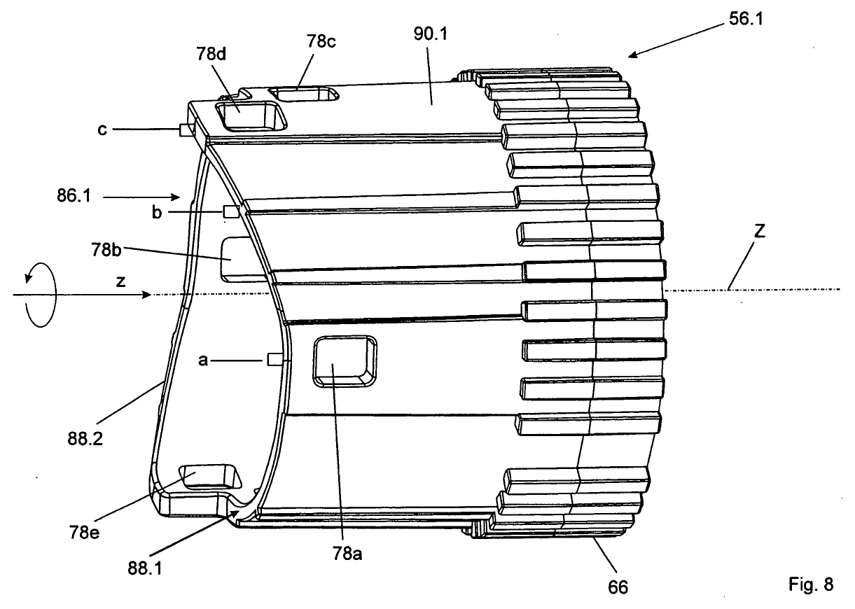

FIG. 8 shows the slider sleeve 56.1 with the guide track 88. The guide track 88 can be described as a guide track function z(φ) if the central axis Z is construed as the z axis, as shown in FIG. 8. The slider sleeve 56.1 has a substantially cylindrical base body 90,1, on the front end 86.1 of which the guide track 88.1 is designed such that two points opposite with respect to the central axis Z have the same z value on the z axis. The guide track 88.1 thus has two sections, a first section 88a and a second section 88b, which follow each other with respect to the radial coordinate (φ). The locking pockets 78a, 78b, . . . 78e are also designed in the base body 90.1.

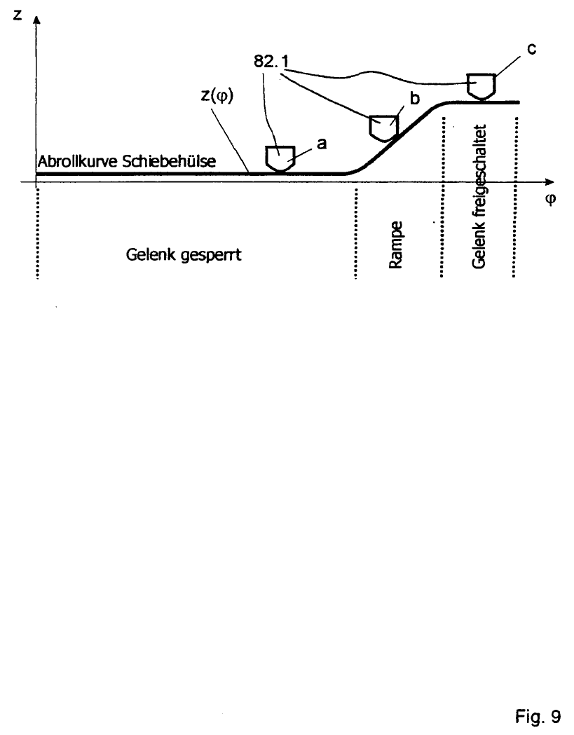

FIG. 9 shows the guide track function z(φ) of the guide track 88.1. The slide element 82.1 (cf. FIG. 7) is schematically illustrated, when situated in three different rotary positions relative to the slider sleeve 56.1. Corresponding positions a, b, c are also shown in FIG. 8. It is evident that the slide element 82 glances off the guide track 88.1 when the slider sleeve 56.1 is rotated.

FIG. 10 shows a cross-section through the first joint 40.1 with the components arranged on a central shaft 92. The slider sleeve 56.1 sits with cogging 94.1 rotatably on the central shaft 92 and can be shifted axially along the central axis Z. A spring 96.1 tenses the slider sleeve 56.1 via the tensing element 58.1 against the front frame head element 48.1 which is connected solidly to the central shaft 92.

If the base body 62.1 of the push rod head elements 52.1 pivots about the fixed central shaft 92 the slide elements 82.1, 83.1, not shown in FIG. 10, (cf. FIG. 7) slide away on the guide track 88.1 or respectively 88.2 and press the slider sleeve 56.1 inwards against the force of the spring 96.1. In the process the outer ribbing 66.1 of the slider sleeve 56.1 disengages from the inner ribbing 64.1 of the rear frame head element 50.1. The rear frame head element 50.1 can then be swivelled relative to the front frame head element 48.1. This happens whenever the push rod angle α (FIG. 1) is less than a folding angle α_{fold}, which here corresponds to the rear frame angle ρ, and the front frame angle γ of in each case −45°.

As shown in FIG. 10, if the push rod angle α is greater than minus 45° the slider sleeve 56.1 is then in the lock position, so that its outer ribbing 66 meshes with the inner ribbing 64 of the rear frame head elements 50.1 and at the same time with the inner ribbing 68 of the front frame head element 48.1, connecting both torque-proof to one another.

Legend

| | |
|---|---|
| 10 | jogger |
| 12 | framework |
| 14 | front frame |
| 16 | rear frame |
| 18 | front frame transverse spar |
| 20 | front frame longitudinal spar |
| 22 | front wheel |
| 24 | rear frame transverse spar |
| 26 | rear frame longitudinal spar |
| 28 | rear wheel |
| 30 | push rod |
| 32 | grip |
| 34 | seat retainer element |
| 36 | seat retainer |
| 38 | central element |
| 40 | joint firsts/seconds |
| 42 | actuation element |
| 46 | finger grip |
| 48 | front frame head element |
| 50 | rear frame head element |
| 52 | push rod head element |
| 54 | cap |
| 56 | slider sleeve |
| 58 | tensing element |
| 60 | coupling section |
| 62 | base body |
| 64 | inner ribbing |
| 66 | outer ribbing |
| 68 | inner ribbing |
| 70 | actuation rod |
| 72 | coupling end |
| 74 | control disc |
| 76 | locking element |
| 78 | locking pocket |
| 80 | guide |
| 82, 83 | slide element |
| 84 | groove |
| 86 | front end |
| 88 | guide track |
| 90 | base body |
| 92 | central shaft |
| 94 | cogging |
| 96 | spring |
| α | push rod angle |
| β | rear frame angle |
| γ | front frame angle |
| B | direction of actuation |
| Z | central axis |
| H | horizontal |
| z | axial coordinate |
| φ | radial coordinate |
| z (φ) | guide track function |

1. A jogger, in particular a child's rehabilitation jogger, with
(a) a framework (12) which comprises
(i) a front frame (14) with at least one front wheel (22) and
(ii) a rear frame (16) with at least one rear wheel (28),
b) a push rod (30) for pushing or pulling the jogger (10),
c) a seat retainer (36) for accommodating a seat and
d) a central element (38), which connects
(i) the front frame (14), the rear frame (16) and the push rod (30) locked and pivotably to one another,
(ii) an actuation element (42) for releasing the central element (38) and
(iii) a slider sleeve (56) which has a lock position, in which the front frame (14) is connected torque-proof to the rear frame (16) and a folding position, in which the front frame (14) can be pivoted relative to the rear frame (16),
characterised in that
e) the central element (38) has at least one slide element (82, 83) and
f) the slider sleeve (56) has a track guide (88), designed to slide away on the slide element (82, 83) such that rotating the slide elements (82) relative to the slider sleeve (56) about a central shaft (92) causes an axial shift of the slider sleeve (56) from the lock position to the folding position.

2. The jogger as claimed in claim 1, characterised in that the guide track (88) is designed on an edge of the slider sleeve (56).

3. The jogger as claimed in claim 2, characterised in that the guide track (88) is designed on an axial outer edge of the slider sleeve (56) facing the slide element (82).

4. The jogger as claimed in claim 3, characterised in that the slider sleeve (56) has a substantially cylindrical base body (90) and the guide track (88) is designed on a front end (86) of the base body.

5. The jogger as claimed in claim 1, characterised in that the slider sleeve (56) is pre-tensed in the lock position.

6. The jogger as claimed in claim 1, characterised in that the slider sleeve (56) is arranged relative to the framework (12) such that it is in the lock position whenever a push rod angle (a) between the push rod (30) and a horizontal (H) is greater than a preset folding angle when the jogger (10) is in use, whereby the folding angle is in particular −45°.

7. The jogger as claimed in claim 1, characterised in that the slider sleeve (56) is arranged relative to the framework (12) such that it is in the folding position whenever the push rod angle (a) is less than the folding angle.

8. The jogger as claimed in claim 6, characterised in that the folding angle corresponds substantially to a front frame angle (γ), at which the front frame (14) runs relative to the horizontal (H), and/or a rear frame angle (β), at which the rear frame (16) runs relative to the horizontal (H).

9. The jogger as claimed in claim 1, characterised in that the central element (38) is connected
to the front frame (14) via a front frame head element (48),
to the rear frame (16) via a rear frame head element (50),
to the push rod (30) via a push rod head element (52),
whereby the front frame head element (48), the rear frame head element (50), the push rod head element (52) and the slider sleeve (56) are swivel-mounted coaxially about the central shaft (92), and
the slide element (82) is designed on the push rod head element (52).

10. The jogger as claimed in claim 9, characterised in that the push rod head element (52) comprises a control disc (74), which can be actuated by the actuation element (42), and at least one locking element (76), which is pre-tensed for locking engagement in at least one locking pocket (78) of the slider sleeve (56), whereby the control disc (74) and the locking element (76) are designed such that actuating the actuation element (42) disengages the locking element (76) from the locking pocket (78), so that the push rod (30) can be pivoted relative to the framework (12).
